(19) United States
(12) Patent Application Publication
(10) Pub. No.: US 2010/0048153 A1
(43) Pub. Date: Feb. 25, 2010

(54) HIGH DEFINITION RADIO DEVICE AND METHOD FOR PROVIDING MUSICAL INFORMATION USING THE SAME

(76) Inventor: JUNG HOON JANG, Busan (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/537,030

(22) Filed: Aug. 6, 2009

(30) Foreign Application Priority Data
Aug. 21, 2008 (KR) 10-2008-0082009

(51) Int. Cl. H04B 1/18

(52) U.S. Cl. 455/185.1

(57) ABSTRACT

A high definition radio device is disclosed, wherein the high definition radio device includes a high definition radio module storing musical information extracted from high definition radiobroadcast; and a host controller transmitting the musical information stored in the high definition radio module to a portable music player.

### CROSS-REFERENCE TO RELATED APPLICATION

This application claims the benefit under 35 U.S.C. §119 of Korean Patent Application No. 10-2008-0082009, filed on Aug. 21, 2008, which is hereby incorporated by reference in its entirety.

### BACKGROUND OF THE INVENTION

1. Field of the Invention

The present invention relates to a high definition radio device and a method for providing musical information using the same.

2. Description of the Related Art

Recently, a high definition radio device capable of receiving high definition radiobroadcast such as High Definition or Digital Audio Broadcasting has spread.

The high definition radio device can receive the high definition radiobroadcast to play radiobroadcast as a high quality of sound. The high definition radio device can provide an enhanced function capable or displaying musical information, e.g., artist name, a subject of song or album information, extracted from data included in the high definition radiobroadcast while the conventional analog radio device cannot provide the enhanced function.

However, the high definition radio device can display the musical information on itself only, and normally cannot provide the musical information to other external apparatus. Recently, a portable musical player such as iPOD (Trademark of Apple Computer) can display song information during song play and can also search or download music files through an on-line access. Thus, it is essential that the high definition radio device be equipped with a function capable of communicating with a portable musical player.

### BRIEF SUMMARY

It is therefore an object of the present disclosure to provide a high definition radio capable of extract musical information from high definition radiobroadcast and providing the same to a portable music player.

In one general aspect of the present disclosure, there is provided a high definition radio device comprising a high definition radio module storing musical information extracted from high definition radiobroadcast, and a host controller transmitting the musical information stored in the high definition radio module to a portable music player.

In another general aspect of the present disclosure, there is provided a method for providing musical information using a high definition radio device, comprising receiving high definition radiobroadcast using the high definition, extracting musical information from the high definition radiobroadcast, connecting the high definition radio device with a portable music player, and transmitting the extracted musical information to the portable music player.

### BRIEF DESCRIPTION OF THE DRAWINGS

FIG. 1 represents an exemplary method for providing musical information to a portable player using a high definition radio device according to the present invention.

FIG. 2 is an exemplary block diagram of a high definition radio device according to the present invention.

FIG. 3 shows an exemplary communication process between a host controller and a high definition radio module in FIG. 2.

FIG. 4 is an exemplary packet format used by the communication process between a host controller and a high definition radio module.

### DETAILED DESCRIPTION

Exemplary implementations of the present disclosure will be described with reference to the accompanying drawings.

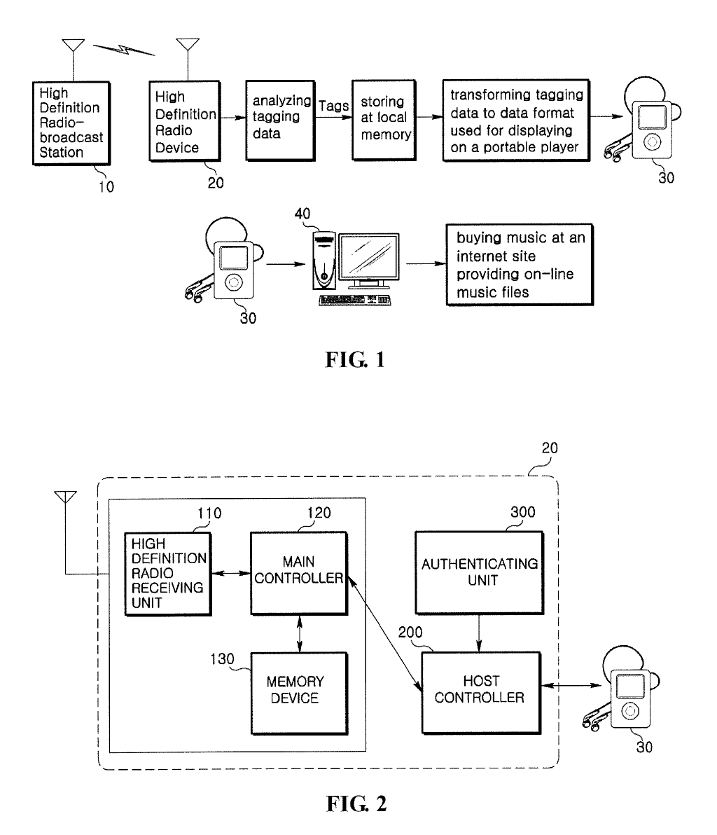

FIG. 1 represents an exemplary method for providing musical information to a portable player using a high definition radio device according to the present invention.

As shown, the high definition radio device 20 receives a high definition radiobroadcast provided by a high definition radiobroadcast station 10. The high definition radio device 20 analyzes data included in the high definition radiobroadcast to extract a tagging data from the data where the tagging data is to be displayed on a portable player 30 while music is played. The tagging data is stored in a memory device of the high definition radio device 20 and provided to a portable player by the high definition radio device 20. Herein, the portable player 30 includes a portable music player.

Also, the high definition radio device 20 transforms the tagging data to data format used for display on a portable player 30 while music is played. For instance, the data format may be extensible markup language (hereinafter called XML). The high definition radio device 20 uploads the tagging data having the transformed data format to the portable player 30.

An user may connect the portable player 30 to a personal computer 40 and access an internet site providing musical files, e.g., iTunes Store (Trademark of Apple Computer). Then, user can easily search or download the music files based on musical information such as the tagging data provided by the high definition radio device 20.

FIG. 2 is an exemplary block diagram of a high definition radio device according to the present invention.

As shown, the high definition radio device 20 includes a high definition radio module 100, a host controller 200, and an authenticating unit 300.

The high definition radio module 100 includes a high definition radio receiving unit 110 for receiving high definition radiobroadcast, a main controller 120 for extracting musical information from data included in the received high definition radiobroadcast, and a memory device 130 for storing the extracted musical information.

Herein, the main controller 120 uses at least one of a station information service (SIS) and a program service data (PSD) included in the high definition radiobroadcast to extract musical information. The station information service includes a radio call sign or information of radiobroadcast station. The program service data includes subject of song, album information, or artist information.

The main controller 120 transforms a first data format of the extracted musical information to a second data format used for displaying on a portable player 30 while music is played. For instance, the data format may be XML adaptable for iPOD™ (Trademark of Apple Computer).

The host controller 200 performs communication between the high definition radio module 100 and a portable music player. Specifically, the host controller 200 transmits musical information stored in the high definition radio module 100 to the portable player 30. The authenticating unit 300 authenticates whether a portable player is available and controls the host controller 200 such that the transmit musical information can be transmitted to an authenticated portable player.

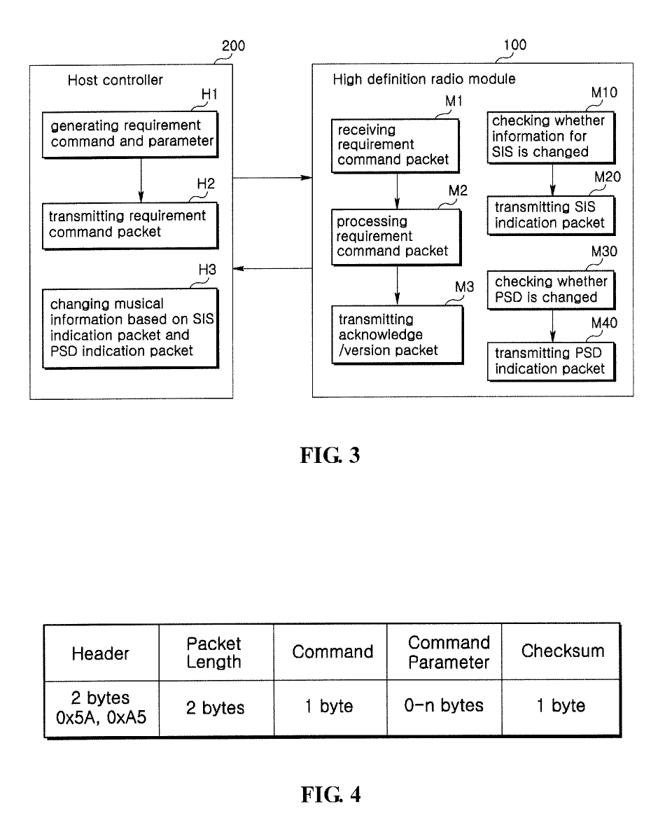

FIG. 3 shows an exemplary communication process between a host controller and a high definition radio module in FIG. 2. FIG. 4 is an exemplary packet format used by the communication process between a host controller and a high definition radio module.

As shown, a user may first connect a portable player 30 to the high definition radio device 20. By touching a predetermined button of the portable player, the host controller 200 can generate a requirement command to require musical information and a parameter (H1). The predetermined button may be a BUY button of iPOD (Trademark of Apple Computer). The host controller 200 packets a requirement command to transmit a requirement command packet to the high definition radio module 100. An exemplary format of the requirement command packet is shown in FIG. 4. The format of the requirement command packet may include a header, a packet length, a command, a command parameter and a checksum.

The high definition radio module 100 receives the requirement command packet from the host controller 200 (M1) and processes the received requirement command packet (M2). The high definition radio module 100 transmits an acknowledge/version packet (M3). The acknowledge/version packet is for acknowledging of the requirement command packet.

The high definition radio module 100 checks whether information for the station information service (SIS) stored in the portable player 30 and the memory device 130 is changed (M10), and an SIS indication packet for changing the information for the station information service (SIS) is transmitted to the host controller 200 (M20).

Furthermore, the high definition radio module 100 checks whether information for the program service data (PSD) stored in the portable player 30 and the memory device 130 is changed (M30), and generates a PSD indication packet for changing the information for the program service data (PSD) and transmits to the host controller 200 (M40).

The host controller 200 receives the SIS indication packet and the PSD indication packet from the high definition radio module 100 and provides changed musical information based on the SIS indication packet and the PSD indication packet to the portable player (H3). The portable player updates stored musical information based on the changed musical information provided by the host controller 200.

An user may connect the portable player 30 with a personal computer 40 and accesses an internet site providing musical files, e.g., iTunes Store (Trademark of Apple Computer). Then, the user can easily search or download the music files based on musical information such as the tagging data provided by the high definition radio device 20.

By the present invention, a high definition radio device can provide service function that extracts musical information from high definition broadcast to supply the musical information to a portable player. The user with the portable player can easily search or download music files based on the musical information.

While the present invention has been described with respect to the specific embodiments, it will be apparent to those skilled in the art that various changes and modifications may be made without departing from the spirit and scope of the invention as defined in the following claims.

What is claimed is:

1. An high definition radio device, comprising:
a high definition radio module storing musical information extracted from high definition radiobroadcast; and
a host controller transmitting the musical information stored in the high definition radio module to a portable music player.

2. The high definition radio device of claim 1, wherein the high definition radio module includes:
a high definition receiver receiving the high definition radiobroadcast;
a main controller extracting the musical information from the high definition radiobroadcast; and
a memory device storing the musical information.

3. The high definition radio device of claim 2, wherein the main controller extracts the musical information using at least one of a station information service and a program service data included in the high definition radiobroadcast.

4. The high definition radio device of claim 2, wherein the main controller performs an operation for transforming the musical information into a data format of a tag displayed on the portable player while music is played.

5. The high definition radio device of claim 4, wherein the data format of the tag includes an XML format.

6. The high definition radio device of claim 4, further comprising an authenticating unit authenticating the portable player to which the host controller transmits the musical information.

7. The high definition radio device of claim 1, wherein communication between the high definition radio module and the host controller is implemented by a packet switching and the packet includes information for a header, a packet length, a command, and a command parameter.

8. A method for providing musical information using a high definition radio device, comprising:
receiving high definition radiobroadcast using the high definition radio device;
extracting musical information from the high definition radiobroadcast;
connecting the high definition radio device to a portable music player; and
transmitting the extracted musical information to the portable music player.

9. The method of claim 8, wherein the step of the extracting musical information uses at least one of a station information service and a program service data included in the high definition radiobroadcast.

10. The method of claim 8, further comprising transforming the musical information into a data format of a tag displayed on the portable player while music is played.

11. The method of claim 10, wherein the data format of the tag includes an XML format.

12. The method of claim 8, further comprising:
entering an on-line site providing musical files based on the extracted musical
information using the portable music player; and
downloading the musical files from the on-line site to the portable music player.
